(19) United States
(12) Patent Application Publication
(10) Pub. No.: US 2024/0416370 A1
(43) Pub. Date: Dec. 19, 2024

(54) ELECTRODE FOR DISCHARGE SURFACE TREATMENT AND PRODUCTION METHOD OF THE SAME

(71) Applicant: IHI Corporation, Tokyo (JP)

(72) Inventors: Hiroki YOSHIZAWA, Tokyo (JP); Kazuki ITO, Tokyo (JP); Hiroshi HORAI, Tokyo (JP)

(73) Assignee: IHI Corporation, Tokyo (JP)

(21) Appl. No.: 18/814,668

(22) Filed: Aug. 26, 2024

Related U.S. Application Data
(63) Continuation of application No. PCT/JP2022/045044, filed on Dec. 7, 2022.

(30) Foreign Application Priority Data
May 18, 2022 (JP) 2022-081644

(51) Int. Cl. B05B 5/053

(52) U.S. Cl. CPC B05B 5/0533

(57) ABSTRACT

Discharge surface treatment is carried out by an electrode provided with a sintered body of a metal micro-powder having a median diameter of 3 micrometers or smaller and a metal macro-powder having a median diameter larger than 3 micrometers and not larger than 10 micrometers, in which the metal micro-powder and the metal macro-powder form an electrode powder containing Cr and oxygen, which is produced by mixing and granulating the metal micro-powder and the metal macro-powder, compressing and molding the granulated powder under a pressure of from 20 MPa to 300 MPa, and firing the compressed body at from 450 degrees C. to 950 degrees C., and the oxygen content rate of the sintered body is 1.5 mass % or higher and 4.0 mass % or lower.

### CROSS-REFERENCE TO RELATED APPLICATIONS

This application is a continuation application of PCT International Application No. PCT/JP2022/045044 (filed Dec. 7, 2022), which is in turn based upon and claims the benefit of priority from Japanese Patent Application No. 2022-081644 (filed May 18, 2022), the entire contents of which are incorporated herein by reference.

### BACKGROUND

The present disclosure relates to an electrode for discharge surface treatment and a production method thereof.

### RELATED ART

A discharge surface treatment is an art for using an electrode for discharge surface treatment composed of a metal, a ceramic or such to generate discharge and thereby form a functional coating on a workpiece. In the discharge surface treatment, a voltage is applied between the electrode and the workpiece and thereby pulsed discharges are reciprocally generated between the electrode and the workpiece. As being promoted by the discharges, an electrode material, in a molten or semi-molten state, migrate to the workpiece and thereby a discharge surface treatment coating consisting of the electrode material or a reaction substance of the electrode material is formed on the surface of the workpiece. See International Publication 2010/119865 pamphlet.

### SUMMARY

And now, the electrode for discharge surface treatment is formed by sintering a fine metal powder generally including Cr (chromium) and oxygen of 3 micrometers or smaller. The discharge surface treatment coating thus contains Cr. As the discharge surface treatment coating contains Cr, during exposure to heat in a real machine such as a jet engine component, Cr is oxidized to form chromium oxide (Cr₂O₃). This chromium oxide functions as a protective oxide film or a high-temperature solid lubricant.

Then, as the aforementioned fine metal powder constituting the electrode contains oxygen, the electrode contains oxygen. If the content rate of the oxygen in the electrode is higher, the rate of Cr contained in the molten or semi-molten electrode material exhausted by oxidation by the oxygen during the discharge surface treatment becomes higher. Consequently the content rate of Cr in the discharge surface treatment coating is reduced and it gives rise to degradation of oxidation resistance or abrasion resistance of the discharge surface treatment coating.

An object of the present disclosure is therefore to provide an electrode for discharge surface treatment and a production method thereof, which is capable of further reducing the content of oxygen contained in the electrode for discharge surface treatment.

An electrode for discharge surface treatment according to the present disclosure is provided with a sintered body in that a metal micro-powder having a median diameter of 3 micrometers or smaller and a metal macro-powder having a median diameter larger than 3 micrometers and not larger than 10 micrometers are sintered together, wherein the metal micro-powder and the metal macro-powder include Cr and oxygen, and wherein an oxide content rate of the sintered body is 1.5 mass % or higher and 4.0 mass % or lower.

A production method for an electrode for discharge surface treatment according to the present disclosure is provided with an electrode powder formation step for forming an electrode powder including a metal micro-powder having a median diameter of 3 micrometers or smaller and a metal macro-powder having a median diameter larger than 3 micrometers and not larger than 10 micrometers, wherein the metal micro-powder and the metal macro-powder include Cr and oxygen; a granulation step for mixing and granulating the metal micro-powder and the metal macro-powder to form a granulated powder; a compression molding step for compressing and molding the granulated powder under a pressure of from 20 MPa to 300 MPa to form a compressed body; and a firing step for firing the compressed body at from 450 degrees C. to 950 degrees C. to form a sintered body.

### BRIEF DESCRIPTION OF THE DRAWINGS

FIG. 1 is a drawing schematically showing a micro structure of an electrode for discharge surface treatment.

FIG. 2 is a flowchart generally representing a process for producing the electrode for discharge surface treatment.

FIG. 3 is an elevational view schematically showing an electric discharge machine used in the discharge surface treatment.

FIG. 4A is a metallurgical microscope image of the electrode for discharge surface treatment in regard to a working example 1.

FIG. 4B is a metallurgical microscope image of the electrode for discharge surface treatment in regard to a working example 2.

FIG. 4C is a metallurgical microscope image of the electrode for discharge surface treatment in regard to a comparative example 1.

FIG. 5A is a sectional metallurgical microscope image of a coating by the discharge surface treatment in regard to the working example 1.

FIG. 5B is a sectional metallurgical microscope image of a coating by the discharge surface treatment in regard to the comparative example 1.

FIG. 6A is a sectional metallurgical microscope image of a test piece treated by the discharge surface treatment after a continuous oxidation test in regard to the working example 1.

FIG. 6B is a sectional metallurgical microscope image of a test piece treated by the discharge surface treatment after the continuous oxidation test in regard to the working example 2.

### DESCRIPTION OF EMBODIMENTS

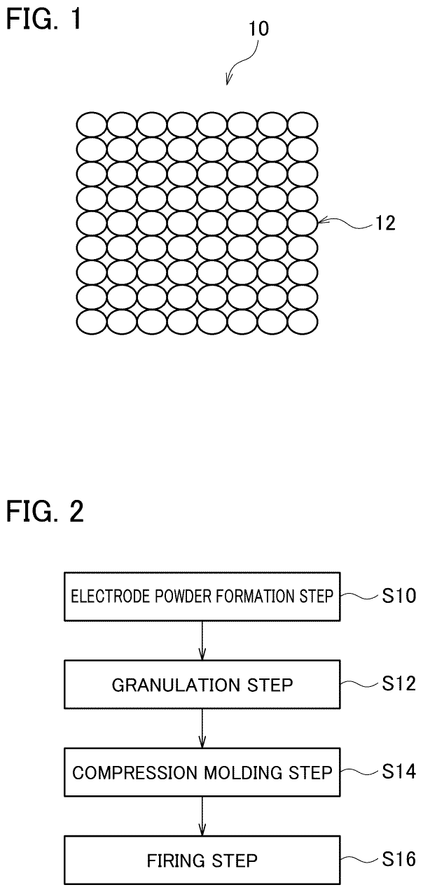

Certain embodiments of the present disclosure will be described hereinafter with reference to the appended drawings. FIG. 1 is a schematic drawing showing a constitution of an electrode 10 for discharge surface treatment. The electrode 10 for discharge surface treatment is provided with a sintered body 12 formed by sintering a metal micro-powder and a metal macro-powder.

The sintered body 12 is formed by sintering a metal micro-powder having a median diameter of 3 micrometers or smaller and a metal macro-powder having a median diameter larger than 3 micrometers and not larger than 10 micrometers together. The metal micro-powder and the metal macro-powder contain Cr (chromium) and oxygen. The median diameter means a particle size for example in which a particle size distribution is first determined by measurement by means of a laser diffraction/scattering method, next the results of the particle size distribution are accumulated in order of increasing size, and the particle size is obtained when the accumulated value reaches 50%. That is, the median diameter means a 50% accumulated particle diameter (D₅₀) in an accumulated particle size distribution.

As the sintered body 12 contains the metal macro-powder, as compared with a case where the sintered body 12 only consists of the metal micro-powder, it is possible to reduce the oxygen content rate of the sintered body 12. Oxygen adsorbs on the surfaces of the metal micro-powder and the metal macro-powder. As the metal micro-powder and the metal macro-powder contain oxygen, in the sintered body 12, oxygen is contained. In regard to the surface areas per unit volume of the metal micro-powder and the metal macro-powder, the metal micro-powder becomes smaller than the metal micro-powder. By this, as the sintered body 12 contains the metal macro-powder, it is enabled to reduce the oxygen content rate of the sintered body 12.

As the sintered body 12 contains the metal micro-powder, the density of the sintered body 12 can be properly regulated not to overly increase the density as compared with the case where the sintered body 12 only consists of the metal macro-powder. The reason is that the metal micro-powder is interposed among the metal macro-powder to properly regulate the density of the sintered body 12. By this, it is possible to suppress thermal conductivity of the electrode 10 for discharge surface treatment to a low level. Consequently, heat of the discharge plasma at the time of the discharge surface treatment hardly escapes out of a tip portion of the electrode 10 for discharge surface treatment so that the temperature of the tip portion of the electrode 10 rises and the electrode material becomes likely to melt or semi-melt.

The metal micro-powder and the metal macro-powder contains Cr (chromium) and oxygen. By this, the sintered body 12 contains Cr and oxygen. As Cr is contained in the electrode 10 for discharge surface treatment constituted of the sintered body 12, Cr can be included in the discharge surface treatment coating. Where Cr is contained in the discharge surface treatment coating, it is possible to form an oxide film including chromium oxide (Cr₂O₃) formed by selective oxidation of Cr contained in the discharge surface treatment coating when the discharge surface treatment coating is exposed to heat in the high-temperature oxidative atmosphere. This oxide film functions as a protective oxide film excellent in oxidation resistance. Further, as chromium oxide functions as a high-temperature solid lubricant, it can improve abrasion resistance.

The metal micro-powder and the metal macro-powder may be formed from a metal material of identical alloy components or a metal material of distinct alloy components. The metal micro-powder and the metal macro-powder are preferably formed from a metal material of identical alloy components. The metal micro-powder and the metal macro-powder may be formed from any thermal resistant metal such as Cr-containing Co (cobalt), Cr-containing Ni (nickel) alloy, or Cr-containing Fe (iron) alloy.

The Cr-containing Co alloy preferably includes 8.5 mass % or more and 32.5 mass % or less Cr in order to improve thermal resistance, oxidation resistance and abrasion resistance. As such the Cr-containing Co alloy, any alloy commercially available in the name of Stellite or Tribaloy (Kennametal Inc.) can be used.

The Stellite alloys are Cr-containing Co alloys that include Cr, Si, W, C and such and its remnant consists of Co and unavoidable impurities. The Stellite alloys for example, while its major components are Co, contain 20 mass % or more and 32.5 mass % or less Cr and 2.0 mass % or less Si and are excellent in thermal resistance and oxidation resistance. The Stellite alloys are, as fine carbides such as WC disperse therein, hard and excellent in abrasion resistance. To the Stellite alloys, for example, a Stellite 31 alloy is applicable.

The Tribaloy alloys are Cr-containing Co alloys that include Cr, Si, Mo and such and its remnant consists of Co and unavoidable impurities. The Tribaloy alloys for example, while its major components are Co, contain 8.5 mass % or more and 18 mass % or less Cr and 1.3 mass % or more and 3.7 mass % or less Si and are excellent in thermal resistance and oxidation resistance. The Tribaloy alloys, as fine intermetallic compounds of Mo and Si disperse therein, are hard and excellent in abrasion resistance. To the Tribaloy alloys, a Tribaloy T-400 alloy or a Tribaloy T-800 alloy is applicable.

To the Cr-containing Ni alloys, an alloy available under the name of Inconel 718 (SPECIAL METALS Corporation), an NiCrAlY alloy, or a NiCoCrAlY alloy is applicable. To the Cr-containing Fe alloys, austenitic stainless steels such as SUS 304 or SUS 316 specified in JIS are applicable.

The metal micro-powder is so composed as to have a median diameter not larger than 3 micrometers. The reason why the median diameter of the metal micro-powder is not larger than 3 micrometers is that the density of the sintered body 12 is likely to be overly large if the median diameter of the micro-powder is larger than 3 micrometers. The median diameter of the metal micro-powder may be made to be not larger than 1 micrometers. The shape of the metal micro-powder may be for example scale-like.

The metal macro-powder is so composed as to have a median diameter not smaller than 3 micrometers and not larger than 10 micrometers. The reason is that the oxygen content rate of the sintered body 12 becomes overly high if the median diameter of the metal macro-powder is smaller than 3 micrometers. The reason is that compression molding is hardly carried out in the later described compression molding step (S14) if the median diameter of the metal macro-powder is larger than 10 micrometers. The shape of the metal macro-powder may be for example spherical or polygonal.

The metal macro-powder may be so composed as to have a median diameter not smaller than 8.5 micrometers and not larger than 10 micrometers. The metal macro-powder may be so composed that the median diameter as a 50% accumulated particle diameter (D₅₀) is not smaller than 8.5 micrometers and not larger than 10 micrometers, the 10% accumulated particle diameter (D₁₀) is not smaller than 3 micrometers and not larger than 5 micrometers, and the 90% accumulated particle diameter (D₉₀) is not smaller than 12 micrometers and not larger than 15 micrometers. By this, as the surface area per unit volume of the metal macro-powder is made further small, the oxygen content rate of the sintered body 12 can be further reduced.

The metal macro-powder may be so composed as to have a median diameter not smaller than 8.9 micrometers and not larger than 10 micrometers. The metal macro-powder may be so composed that the median diameter as a 50% accumulated particle diameter (D₅₀) is not smaller than 8.9 micrometers and not larger than 10 micrometers, the 10% accumulated particle diameter (D₁₀) is not smaller than 3 micrometers and not larger than 5 micrometers, and the 90% accumulated particle diameter (D₉₀) is not smaller than 12 micrometers and not larger than 15 micrometers. By this, as the surface area per unit volume of the metal macro-powder is made still further small, the oxygen content rate of the sintered body 12 can be still further reduced.

In the metal macro-powder, in addition to the aforementioned particle sizes, the maximum particle size may be set to be not larger than 53 micrometers. The metal macro-powder may be so composed as to have a median diameter not smaller than 3 micrometers and not larger than 10 micrometers and as well have a maximum particle size not larger than 53 micrometers. The metal macro-powder may be so composed as to have a median diameter not smaller than 8.5 micrometers and not larger than 10 micrometers and as well have a maximum particle size not larger than 53 micrometers. The metal macro-powder may be so composed as to have a median diameter not smaller than 8.9 micrometers and not larger than 10 micrometers and as well have a maximum particle size not larger than 53 micrometers.

In the metal macro-powder, in addition to the aforementioned particle sizes, the maximum particle size may be set to be not larger than 22 micrometers. The metal macro-powder may be so composed as to have a median diameter not smaller than 3 micrometers and not larger than 10 micrometers and as well have a maximum particle size not larger than 22 micrometers. The metal macro-powder may be so composed as to have a median diameter not smaller than 8.5 micrometers and not larger than 10 micrometers and as well have a maximum particle size not larger than 22 micrometers. The metal macro-powder may be so composed as to have a median diameter not smaller than 8.9 micrometers and not larger than 10 micrometers and as well have a maximum particle seize not larger than 22 micrometers.

The content rate of the metal macro-powder may be set to be higher than 0 mass % and not lower than 70 mass % where the sum of the metal micro-powder and the metal macro-powder is 100 mass %. The reason is that the density of the sintered body 12 would possibly become overly large if the content rate of the metal macro-powder were higher than 70 mass %.

The content rate of the metal macro-powder may be set to be not lower than 50 mass % and not higher than 70 mass % where the sum of the metal micro-powder and the metal macro-powder is 100 mass %. The oxygen content rate of the sintered body 12 can be further reduced by setting the content rate of the metal macro-powder to be 50 mass % or higher.

The content rate of the metal macro-powder may be set to be not lower than 60 mass % and not higher than 70 mass % where the sum of the metal micro-powder and the metal macro-powder is 100 mass %. The oxygen content rate of the sintered body 12 can be still further reduced by setting the content rate of the metal macro-powder to be 60 mass % or higher.

The oxygen content rate of the sintered body 12 may be not lower than 1.5 mass % and not higher than 4.0 mass %. If the oxygen content rate of the sintered body 12 falls in this range, a rate at which Cr contained in the molten or semi-molten electrode material during discharge surface treatment is exhausted by oxidation by oxygen contained in the electrode 10 for discharge surface treatment can be reduced. As its result, reduction of the Cr content rate in the discharge surface treatment coating is reduced and thereby oxidation resistance and abrasion resistance of the discharge surface treatment coating are improved.

In a case where the oxygen content rate of the sintered body 12 is lower than 1.5 mass %, as the content rate of the metal micro-powder contained in the sintered body 12 is reduced, the density of the sintered body 12 may be possibly overly large. In a case where the oxygen content rate of the sintered body 12 is higher than 4.0 mass %, the rate at which Cr contained in the molten or semi-molten electrode material during discharge surface treatment is exhausted by oxidation by oxygen contained in the electrode 10 for discharge surface treatment becomes higher. The oxygen content rate of the sintered body 12 is measurable by a general infra-red ray absorption method or such.

The oxygen content of the sintered body 12 may be set to be not smaller than 1.5 mass % and not larger than 3.8 mass %, or not smaller than 1.5 mass % and not larger than 2.5 mass %. By this, the rate at which Cr contained in the molten or semi-molten electrode material during discharge surface treatment is exhausted by oxidation by oxygen contained in the electrode 10 for discharge surface treatment is further lowered. Consequently reduction of the Cr content rate in the discharge surface treatment coating is further reduced and thereby oxidation resistance and abrasion resistance of the discharge surface treatment coating are further improved.

The oxygen content of the sintered body 12 may be set to be not smaller than 2.0 mass % and not larger than 3.8 mass %, or not smaller than 2.0 mass % and not larger than 2.5 mass %. By this, it is possible to carry out in a balanced way suppression of excessive density increase of the sintered body 12 and reduction of oxygen content in the sintered body 12.

Further, even in a case where the metal micro-powder and the metal macro-powder include, besides Cr, Al or Si that forms a good protective oxide film, as long as the oxygen content of the sintered body 12 falls within the aforementioned range, the rate at which Al or Si contained in the molten or semi-molten electrode material during discharge surface treatment is exhausted by oxidation by oxygen contained in the electrode 10 for discharge surface treatment is lowered. Consequently, reduction of the Al content rate or the Si content rate in the discharge surface treatment coating is suppressed and thereby oxidation resistance and abrasion resistance of the discharge surface treatment are improved.

The electric resistivity of the sintered body 12 may be set to be not smaller than 3 mΩ·cm and not larger than 30 mΩ·cm. The electric resistivity of the sintered body 12 can be measured by any commonly used method such as a four-terminal method. The electric resistivity increases because the thermal conductivity and the electric resistivity are negatively correlated and therefore the electric resistivity gets larger as the thermal conductivity gets smaller. If the electric resistivity of the sintered body 12 falls within this range, it can sufficiently follow the cycles of the pulses and further the thermal conductivity can be properly suppressed. By this, as heat of the discharge plasma hardly escapes from the tip portion of the electrode 10, the tip portion of the electrode for discharge surface treatment can be kept at a high temperature.

The density of the sintered body 12 may be set to be not smaller than 3 g/cm³ and not larger than 5 g/cm³. The density of the sintered body 12 can be measured by any density measurement method such as the Archimedean method. The density of the sintered body 12 is intimately related to the electric resistivity of the sintered body 12. If the density of the sintered body 12 is not smaller than 3 g/cm³ and not larger than 5 g/cm³, the electric resistivity of the sintered body 12 can be made to be not smaller than 3 mΩ·cm and not larger than 30 mΩ·cm.

Next, the production method of the electrode 10 for discharge surface treatment will be described. FIG. 2 is a flowchart depicting a constitution of the production method of the electrode 10 for discharge surface treatment. The production method of the electrode 10 for discharge surface treatment is provided with an electrode powder formation step (S10), a granulation step (S12), a compression molding step (S14) and a firing step (S16).

The electrode powder formation step (S10) is a step for forming an electrode powder consisting of a metal micro-powder having a median diameter of 3 micrometers or smaller and a metal macro-powder having a median diameter larger than 3 micrometers and not larger than 10 micrometers, in which the metal micro-powder and the metal macro-powder contain Cr and oxygen.

A metal powder such as a Cr-containing Co alloy, a Cr-containing Ni alloy or a Cr-containing Fe alloy can be used as an ingredient powder. A Cr-containing alloy powder is used as the ingredient powder. The electrode powder can be therefore formed, in which the metal micro-powder and the metal macro-powder contain Cr. Further, oxygen is absorbed on the surfaces of the powder. The electrode powder can be therefore formed, in which the metal micro-powder and the metal macro-powder contain oxygen.

An alloy powder formed by an atomizing method or such can be used as the ingredient powder. To the atomizing method, a water-atomizing method, a gas-atomizing method or such is applicable. An alloy powder having a maximum particle size not larger than 22 micrometers, or an alloy powder having a maximum particle size not larger than 53 micrometers, for example, can be used as the ingredient powder. To the ingredient powder, any commercially available product is applicable.

The metal micro-powder having a median diameter of 3 micrometers or smaller and the metal macro-powder having a median diameter larger than 3 micrometers and not larger than 10 micrometers may be formed for example by atomizing the ingredient powder by means of a jet mill or such. To the jet mill, a swirl flow jet mill or such is applicable. In regard to the atomizing pressure, 0.4 MPa or lager and 2.6 MPa or smaller is preferable.

The metal mass-powder is classified and collected by a cyclone. The metal micro-powder is collected by a bug filter or such. The metal macro-powder can be formed in a spherical shape or a polygonal shape for example. The metal micro-powder can be formed in a scale shape.

The metal macro-powder may be further classified through a sieve or such into a predetermined particle size. By classifying the metal macro-powder through a sieve, the particle diameter of the metal macro-powder may be regulated so that its median diameter as the 50% accumulated particle diameter (D₅₀) is not smaller than 8.5 micrometers and not larger than 10 micrometers, the 10% accumulated particle diameter (D₁₀) is not smaller than 3 micrometers and not larger than 5 micrometers, and the 90% accumulated particle diameter (D₉₀) is not smaller than 12 micrometers and not larger than 15 micrometers.

The granulation step (S12) is a step for mixing the metal micro-powder having a median diameter not larger than 3 micrometers and the metal micro-powder having a median diameter not smaller than 3 micrometers and not larger than 10 micrometers, and granulating them to form the granulated powder.

First, slurry is produced, in which the metal micro-powder and the metal macro-powder are mixed. The mixing ratio of the metal macro-powder can be larger than 0 mass % and not larger than 70 mass % where a sum of the metal micro-powder and the metal macro-powder is 100 mass %. The mixing ratio of the metal macro-powder can be not smaller than 50 mass % and not larger than 70 mass % where a sum of the metal micro-powder and the metal macro-powder is 100 mass %, or not smaller than 60 mass % and not larger than 70 mass %.

The slurry is produced by admixing the metal micro-powder, the metal macro-powder, a binder and a lubricant with a solvent stored in a storage tank and then stirring and mixing them. As the solvent, any organic solvent or such can be used. 200 mass % of the solvent is preferably admixed where a sum of the metal micro-powder and the metal macro-powder is 100 mass %.

As the binder, for example, any thermoplastic resin such as polypropylene (PP), polyethylene (PE), polymethylmethacrylate (PMMA) and polyvinyl alcohol (PVA), or any polysaccharide substance such as agar is used. From 2 mass % to 3 mass % of the binder is preferably admixed where a sum of the metal micro-powder and the metal macro-powder is 100 mass %.

As the lubricant, stearic acid, paraffin wax, zinc stearate or such can be used. From 1 mass % to 10 mass % of the lubricant is preferably admixed where a sum of the metal micro-powder and the metal macro-powder is 100 mass %.

After producing the slurry, the granulated powder is formed by using a spray drier or such. In a case of using the spray drier to execute granulation, the slurry is injected through a nozzle of the spray drier into a high-temperature nitrogen gas atmosphere in the spray drier. The solvent contained in the slurry is thus dried and removed to form the granulated powder.

The compression molding step (S14) is a step for compressing and molding the granulated powder under a pressure of from 20 MPa to 300 MPa to form a compressed body. A mold is filled with the granulated powder and is pressed by a press machine to carry out molding. The granulated powder is thus compressed and molded to form the compressed body. The pressure for the molding is preferably for example from 20 MPa to 300 MPa.

The compressed body may be, after the molding, finally pressed by CIP (cold isostatic pressing). As the compressed body can be isotropically pressed by the CIP, the density distribution of the compressed body can be made more uniform. The pressure of the CIP is preferably changed on the basis of the mixing ratio of the metal micro-powder and the metal macro-powder. The pressure of the CIP is preferably made smaller as the mixing ratio of the metal macro-powder is larger, but the pressure is preferably made larger as the mixing ratio of the metal macro-powder is smaller.

In a case where the metal macro-powder is in a ratio larger than 0 mass % and not larger than 70 mass % where the sum of the metal micro-powder and the metal macro-powder is 100 mass %, the pressure of the CIP is preferably from 20 MPa to 300 MPa. In a case where the metal macro-powder is in a ratio not smaller than 50 mass % and not larger than 70 mass % where the sum of the metal micro-powder and the metal macro-powder is 100 mass %, the pressure of the CIP is preferably from 20 MPa to 120 MPa. In a case where the metal macro-powder is in a ratio not smaller than 60 mass % and not larger than 70 mass % where the sum of the metal micro-powder and the metal macro-powder is 100 mass %, the pressure of the CIP is preferably from 20 MPa to 60 MPa.

The firing step (S16) is a step for firing the compressed body at a temperature not lower than 450 degrees C. and not higher than 950 degrees C. to form the sintered body 12. The compressed body is fired by using a heating furnace such as a vacuum heater furnace or an atmosphere furnace. By using a heater or such, in a vacuum, an inert gas atmosphere or a reductive atmosphere, the compressed body is subject to heating and then fired. The firing is executed to a degree such that bonding at contacts between powder particles is properly strengthened in a state where the electrode powder keeps its shape. The duration of the firing temperature may be 5 hours or longer and 15 hours or shorter.

In a case where the firing temperature is lower than 450 degrees C., the bonding at the contacts between the powder particles is likely to be weakened. In a case where the firing temperature is higher than 950 degrees C., the bonding at the contacts between the powder particles is likely to be excessively strengthened. The firing temperature is preferably not lower than 700 degrees C. and not higher than 800 degrees C. Consequently the bonding at the contacts between the powder particles can be properly strengthened.

In the firing step (S16), the compressed body is preferably fired at a higher temperature as the mixing ratio of the metal mass-powder is larger, but the compressed body is preferably fired at a lower temperature as the mixing ratio of the metal mass-powder is smaller. Thus, even in a case where the electrode powder includes the metal mass-powder, the bonding at the contacts between the powder particles can be properly strengthened.

The compressed body is preferably fired in a vacuum or a reductive atmosphere. Thus, as oxygen contained in the metal micro-powder and the metal macro-powder constituting the compressed body is likely to be removed, the oxygen content rate of the sintered body 12 can be further reduced.

The sintered body 12 produced in a way as described above is so constituted as to have an oxygen content rate not lower than 1.5 mass % and not higher than 4.0 mass %. Further, the sintered body 12 is preferably constituted to have an electric resistivity not smaller than 3 mΩ·cm and not larger than 30 mΩ·cm and a density not smaller than 3 g/cm³ and not larger than 5 g/cm³. In a way as described above, the electrode 10 for discharge surface treatment constituted of the sintered body 12 is produced.

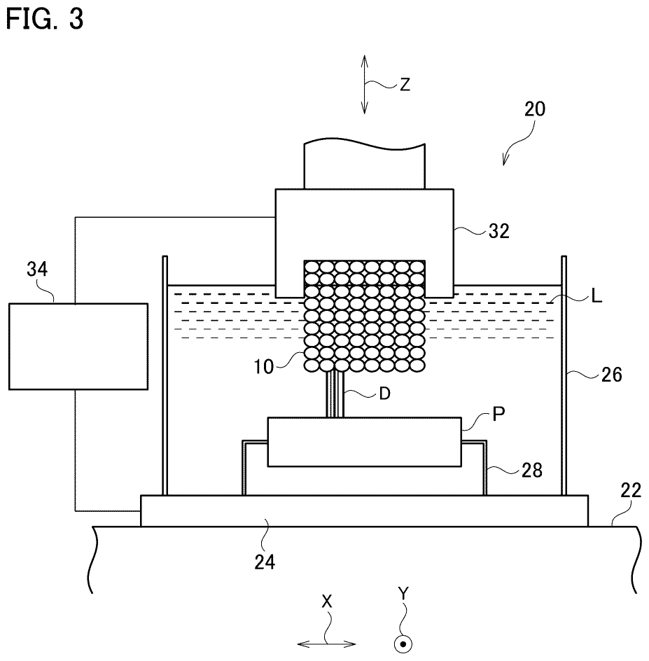

Next, the discharge surface treatment using the electrode 10 for discharge surface treatment will be described. First, the electric discharge machine used in the discharge surface treatment will be described. FIG. 3 is a schematic drawing showing a constitution of the electric discharge machine 20.

The electric discharge machine 20 is provided with a bed 22. On the bed 22, a table 24 is provided. On the table 24, a liquid bath 26 for storing electrically insulating liquid L such as insulating oil is provided. In the liquid bath 26, a jig 28 ready for a component P formed of a Ni alloy or such being set thereon is provided.

Above the table 24, an electrode holder 32 for holding the electrode 10 for discharge surface treatment is provided to be movable in a X-axis direction, a Y-axis direction and a Z-axis direction. The electrode holder 32 is so constituted as to be rotatable about the Z-axis. To the jig 28 and the electrode holder 32, a discharge power supply device 34 is electrically connected. To the discharge power supply device 34, any publicly known discharge power supply device is applicable.

Next, the method of discharge surface treatment will be described. The component P is set on the jig 28. By moving the electrode holder 32 holding the electrode 10 for discharge surface treatment in the X-direction or the Y-direction, the electrode 10 for discharge surface treatment is set in place relative to the component P. Next, with reciprocating the electrode holder 32 in the Z-direction, pulsed discharges D are generated between the electrode 10 for discharge surface treatment and the component P in the electrically insulating liquid L by means of the discharge power supply device 34. By means of energy from the discharges D, the electrode material or the reaction substance of the electrode material are made to adhere onto the surface of the component P to form the discharge surface treatment coating.

In concrete terms, when the discharges D are generated between the electrode 10 for discharge surface treatment and the component P, a part of the electrode material is separated from the electrode 10 for discharge surface treatment by means of blast or electrostatic force and is as well made into a molten or semi-molten state by means of heat of the discharge plasma. The separated part of the electrode material in the molten or semi-molten state moves toward the component P and reaches the surface of the component P, and re-solidifies into metal particles. By continuously generating the pulsed discharges, the electrode material on the tip portion of the electrode sequentially moves to the surface of the component P, re-solidifies there and deposits thereon. The metal particles are thus layered on the surface of the component P to form the discharge surface treatment coating. In the meantime, in the constitution described above, discharge surface treatment in the electrically insulating liquid L was described, whereas the discharge surface treatment can be executed in the air or such.

The electrode 10 for discharge surface treatment is so constituted that the oxygen content rate of the sintered body 12 is not lower than 1.5 mass % and not higher than 4.0 mass %. Exhaustion of Cr contained in the molten or semi-molten electrode material by oxidation is thus suppressed at a time of the discharge surface treatment. Consequently reduction of the Cr content rate of the discharge surface treatment coating is suppressed. The electrode 10 is preferably constituted of the sintered body 12 having an electric resistivity not smaller than 3 mΩ·cm and not larger than 30 mΩ·cm and a density not smaller than 3 g/cm³ and not larger than 5 g/cm³. The discharge surface treatment can be therefore more stably executed.

Meanwhile the component P may be a gas turbine component or such. The gas turbine component is for example a component thermally exposed to a high-temperature atmosphere over 1000 degrees C. such as a jet engine component for an airplane or a gas turbine component for industrial use. As the jet engine component for the airplane, for example, a turbine blade unitized with a shroud part is exemplified.

The component P may be a sliding component. On a sliding surface of the sliding component, for example, fretting wear in that facial pressure acts thereon and minute repeating slide repeats or impact wear in that pressure and slide cyclically repeat is generated. For example, by covering the sliding surface of the component P with the discharge surface treatment coating formed of the Cr-containing Co alloy or such, abrasion resistance can be retained even in a high-temperature atmosphere over 1000 degrees C.

In sum, in accordance with the aforementioned constitution, the electrode for discharge surface treatment is formed by sintering the metal micro-powder having a median diameter of 3 micrometers or smaller and the metal macro-powder having a median diameter larger than 3 micrometers and not larger than 10 micrometers and is provided with the sintered body having the oxygen content rate 1.5 mass % or higher and 4.0 mass % or lower. And, the metal micro-powder and the metal macro-powder include Cr and oxygen. In the electrode for discharge surface treatment as constituted as above, the oxygen content rate is thus reduced. Exhaustion of Cr contained in the molten or semi-molten electrode material by oxidation is thus suppressed at a time of the discharge surface treatment. Consequently reduction of the Cr content rate of the discharge surface treatment coating is suppressed.

### Working Example

Properties of the electrode for discharge surface treatment were tested by executing discharge surface treatment after forming the electrode for discharge surface treatment.

### (Formation of the Electrode for Discharge Surface Treatment)

First, a method for forming the electrode for discharge surface treatment will be described. As electrodes for discharge surface treatment, three types of electrodes, namely electrodes of the working examples 1 and 2 and an electrode of the comparative example 1, were produced. In these electrodes, the ratios of the metal micro-powder and the metal macro-powder as described later, the pressures of CIP (cold isostatic pressing), and the temperatures for firing were differentiated but the other constitution was identical. Next, the method for forming the respective electrodes will be described.

A Stellite 31 alloy powder that is a Cr-containing Co alloy powder was used for the ingredient powder. The alloy composition of the Stellite 31 alloy contains from 9.5% to 11.5% Ni, 2.0% or less Fe, from 0.45% to 0.55% Cr, from 24.5% to 26.5% Cr, 1.0% Mn, 1.0% Si, and 7.5% W in mass ratio, and its remnant consists of Co and unavoidable impurities. The powder having a maximum particle diameter of 53 micrometers was used for the ingredient powder. The atomized powder was used for the ingredient powder.

The ingredient powder was atomized by means of a swirl flow jet mill under a compressor pressure of 1.2 MPa. The metal macro-powder was collected by a cyclone and classified through a sieve. The metal micro-powder was collected by a bug filter. The shape of the metal macro-powder was spherical. The shape of the metal micro-powder was scale-like.

The particle size distribution was measured by means of a laser diffraction/scattering method. The median diameter of the metal micro-powder was not larger than 3 micrometers. The median diameter of the metal macro-powder was not smaller than 3 micrometers and not larger than 10 micrometers. In more detail, the median diameter, as a 50% accumulated particle diameter (D₅₀), of the metal macro-powder was 8.9 micrometers, the 10% accumulated particle diameter (D₁₀) was 4.0 micrometers and the 90% accumulated particle diameter (D₉₀) was 13.8 micrometers.

The metal micro-powder and the metal macro-powder were subject to measurement of oxygen concentrations by the infra-red absorption method. Oxygen was detected in both the metal micro-powder and the metal macro-powder. The oxygen concentration of the metal micro-powder was larger than the oxygen concentration of the metal macro-powder.

By mixing and granulating the metal micro-powder and the metal macro-powder, granulated powders were formed. By mixing and stirring the metal micro-powder, the metal macro-powder, a binder, a lubricant and a solvent in a stirrer, slurry was produced. As the binder, an acrylic resin binder was used. As the lubricant, stearic acid was used. As the solvent, isopropyl alcohol (IPA) was used.

In the electrode of the working example 1, the metal micro-powder was 30 mass % and the metal macro-powder was 70 mass % where the sum of the metal micro-powder and the metal macro-powder is 100 mass %. In the electrode of the working example 2, the metal micro-powder was 50 mass % and the metal macro-powder was 50 mass % where the sum of the metal micro-powder and the metal macro-powder is 100 mass %. In the comparative example 1, the metal micro-powder was 100 mass % and it merely consists of the metal micro-powder.

By admixing 2 mass % of the binder with the mixed powder of the metal micro-powder and the metal macro-powder, and further by admixing and stirring 200 mass % of isopropyl alcohol (IPA) with it, the slurry was produced. After producing the slurry, by drying out the solvent by using a spray drier, granulated powders were formed.

Next, the granulated powders were compressed and molded to form compressed bodies. A mold was filled with any of the granulated powders and pressed by a press machine to execute molding. The pressing pressure was from 20 MPa to 300 MPa. In regard to the sizes of the compressed bodies, the rectangular shape of 14 mm in length×110 mm in width×7 mm in height was applied.

After molding, the compressed bodies were subject to CIP (cold isostatic pressing) as final pressing. In regard to the pressure of CIP, smaller pressures were applied as the mixing ratios of the metal macro-powders were smaller. In the electrode of the working example 1, the pressure of CIP was 40 MPa. In the electrode of the working example 2, the pressure of CIP was 80 MPa. In the electrode of the comparative example 1, the pressure of CIP was 250 MPa.

By heating and firing the compressed bodies, sintered bodies were obtained. In regard to the method of firing, as well as mixed gas of argon gas and hydrogen gas was made to flow, a rotary pump was used to draw a vacuum and then firing was executed. The mixed gas of 95 mass % Ar-5 mass % H₂ was used. The firing temperature was set in the range from 700 degrees C. to 800 degrees C. and the keeping duration was 6 hours so as to regulate the electric resistivity. The firing temperatures were made to be higher as the mixing ratios of the metal macro-powders were larger. In more detail, the firing temperature about the electrode of the working example 1 was highest and that of the comparative example 1 was lowest, and the temperature for the electrode of the working example 2 was medium therebetween. The electrodes for discharge surface treatment were thus formed.

On the electrodes of the working examples 1 and 2 and the electrode of the comparative example 1, electric resistivity measurement was carried out by a four-terminal method. The electrode of the working example 1 had a resistivity of 15 mΩ·cm. The electrode of the working example 2 had a resistivity of 18 mΩ·cm. The electrode of the comparative example 1 had a resistivity of 12 mΩ·cm.

On the electrodes of the working examples 1 and 2 and the electrode of the comparative example 1, densities were measured by the Archimedean method. The electrode of the working example 1 had a density of 4.4 g/cm³. The electrode of the working example 2 had a density of 4.0 g/cm³. The electrode of the comparative example 1 had a density of 3.6 g/cm³.

On the electrodes of the working examples 1 and 2 and the electrode of the comparative example 1, oxygen content rates were measured by an infra-red absorption method. The electrode of the working example 1 contained 2.1 mass % oxygen. The electrode of the working example 2 contained 3.2 mass % oxygen. The electrode of the comparative example 1 contained 6.0 mass % oxygen. The electrode of the working example 1 exhibited the lowest oxygen content rate. The electrode of the comparative example 1 exhibited the highest oxygen content rate.

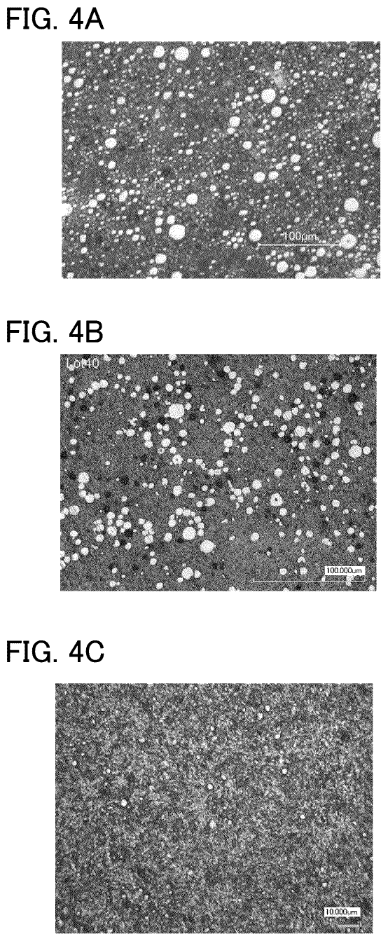

On the electrodes of the working examples 1 and 2 and the electrode of the comparative example 1, metallographic observation was carried out by means of a scanning electron microscope (SEM). FIG. 4 are photographs showing metallographic observation results about the electrodes of the working examples 1 and 2 and the electrode of the comparative example 1, in which FIG. 4A is a photograph about the electrode of the working example 1, FIG. 4B is a photograph about the electrode of the working example 2, and FIG. 4C is a photograph about the electrode of the comparative example 1.

In the metallographic structures of the electrodes of the working examples 1 and 2, as shown in FIGS. 4A and 4B, spherical particles of the metal macro-powder shown in white circles and scale-like particles of the metal micro-powder filling gaps of the metal macro-powder were observed. The metallographic structures of the electrodes of the working examples 1 and 2 were constituted in that the metal macro-powder disperses. On the other hand, in the metallographic structure of the electrode of the comparative example 1, as shown in FIG. 4C, it was constituted of a uniform metallographic structure constituted of the scale-like metal micro-powder.

### (Discharge Surface Treatment)

By using the electrodes of the working examples 1 and 2 and the electrode of the comparative example 1, discharge surface treatment was executed. Substrates were subject to discharge surface treatment in an electrically insulating oil by using an electric discharge machine to form discharge surface treatment coatings on the substrates. The substrates were formed of a Ni alloy. In regard to the discharge condition, peak current values Ip at initial parts of waveforms of discharge pulsed current were 30 A or 40 A, peak current values Ie at intermediate terms or later were regulated to be from 1 A to 25 A, and pulse widths te were regulated to be from 2 microseconds to 30 microseconds. Further, the intermission time was 64 microseconds. The coating thicknesses of the discharge surface treatment coatings were from 300 micrometers to 400 micrometers. The electrodes of the working examples 1 and 2 and the electrode of the comparative example 1 were capable of being treated with discharge surface treatment.

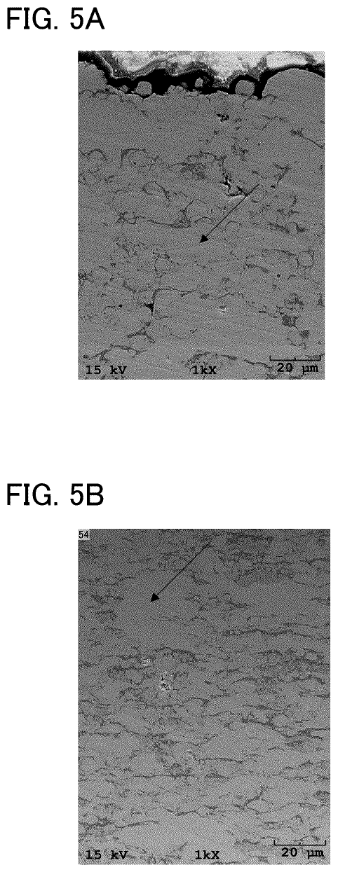

The Cr concentrations were measured on the discharge surface treatment coatings treated with discharge surface treatment by the electrodes of the working example 1 and the comparative example 1. The Cr concentrations are measured by a scanning electron microscopy—energy dispersive X-ray spectroscopy (SEM-EDS) method. FIG. 5 are photographs showing points for the Cr concentration measurement on the discharge surface treatment coatings treated with discharge surface treatment by using the electrodes of the working example 1 and the comparative example 1. FIG. 5A is a photograph showing a point for the Cr concentration measurement on the discharge surface treatment coating treated with discharge surface treatment by using the electrode of the working example 1. FIG. 5B is a photograph showing a point for the Cr concentration measurement on the discharge surface treatment coating treated with discharge surface treatment by using the electrode of the comparative example 1. In FIG. 5A and FIG. 5B, arrows depict the points for the Cr concentration measurement.

The discharge surface treatment coating treated with the electrode of the working example 1 had a Cr concentration of 23.9 mass %. The discharge surface treatment coating treated with the electrode of the comparative example 1 had a Cr concentration of 17.5 mass %. The discharge surface treatment coating treated with the electrode of the working example 1 was higher in Cr concentration than the discharge surface treatment coating treated with the electrode of the comparative example 1.

It is considered that, in electrode of the comparative example 1, the rate of Cr contained in the molten or semi-molten electrode material exhausted by oxidation by the oxygen during the discharge surface treatment was heightened because the content rate of the oxygen in the electrode was highest. It is considered that resultantly the Cr content rate in the discharge surface treatment coating was reduced.

In contrast, it is considered that, in the electrode of the working example 1, the rate of Cr contained in the molten or semi-molten electrode material exhausted by oxidation by the oxygen during the discharge surface treatment was lowered because the content rate of the oxygen in the electrode was lower than that of the electrode of the comparative example 1. It is considered that resultantly reduction of the Cr content rate in the discharge surface treatment coating was suppressed.

### (Oxidation Resistance Test)

The test pieces treated with discharge surface treatment by using the electrodes of the working examples 1 and 2 and the electrode of the comparative example 1 were subject to an oxidation resistance test. In the oxidation resistance test, the test pieces treated with discharge surface treatment by using the respective electrodes were subject to a continuous oxidation test in which the test pieces were continuously thermally exposed to an air atmosphere at 1080 degrees C. for 100 hours. The discharge surface treatment coatings after the continuous oxidation test were observed by a scanning electron microscope (SEM).

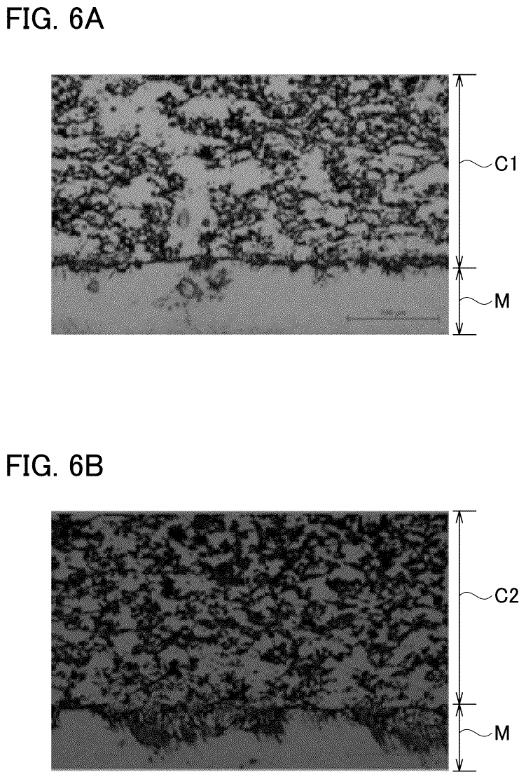

In the test piece treated with discharge surface treatment by using the electrode of the comparative example 1, the discharge surface treatment coating was thoroughly peeled off after the continuous oxidation test. In the test pieces treated with discharge surface treatment by using the electrodes of the working examples 1 and 2, exfoliation of the discharge surface treatment coatings were not observed even after the oxidation test. FIG. 6 are photographs showing the sectional observation results about the test pieces treated with discharge surface treatment by using the electrodes of the working examples 1 and 2 after the continuous oxidation test, in which FIG. 6A is a photograph of the test piece treated with discharge surface treatment by using the electrode of the working example 1 and FIG. 6B is a photograph of the test piece treated with discharge surface treatment by using the electrode of the working example 2. A range indicated by a reference sign M is the substrate and ranges indicated by reference signs C1 and C2 are respectively the discharge surface treatment coatings. In the test pieces treated with discharge surface treatment by using the electrodes of the working examples 1 and 2, the discharge surface treatment coatings remained and cohered with these substrates even after the continuous oxidation test.

It is considered that, in the discharge surface treatment coating treated with discharge surface treatment by using the electrode of the comparative example 1, reduction of the Cr content rate in the discharge surface treatment coating caused reduction of the oxidation resistance. In contrast, it is considered that, in the discharge surface treatment coatings treated with discharge surface treatment by using the electrode of the working examples 1 and 2, the oxidation resistance was improved because reduction of the Cr content rates in the discharge surface treatment coatings was suppressed.

Next, the test pieces treated with discharge surface treatment by using the working examples 1 and 2 were subject to a cyclic oxidation test. The cyclic oxidation test was executed by thermal exposure at from 100 degrees C. to 1100 degrees C. in 500 cycles. In the test piece treated with discharge surface treatment by using the working example 2, some exfoliation of the discharge surface treatment coating was observed. In contrast in the test piece treated with discharge surface treatment by using the working example 1, exfoliation of the discharge surface treatment coating was not observed.

From these results, it is understood that the electrode of the working example 1 can create a discharge surface treatment coating more excellent in oxidation resistance than the electrode of the working example 2 does. The principal reason can be considered to be that reduction of the Cr content rate in the discharge surface treatment coating by using the electrode of the working example 1 was suppressed as compared with the discharge surface treatment coating by using the electrode of the working example 2 because the electrode of the working example 1 had a lower oxygen content rate than the electrode of the working example 2.

Although certain embodiments have been described above, modifications and variations of the embodiments described above will occur to those skilled in the art, in light of the above teachings.

What is claimed is:

1. An electrode for discharge surface treatment, comprising:
a sintered body in that a metal micro-powder having a median diameter of 3 micrometers or smaller and a metal macro-powder having a median diameter larger than 3 micrometers and not larger than 10 micrometers are sintered together,
wherein the metal micro-powder and the metal macro-powder include Cr and oxygen, and
wherein an oxide content rate of the sintered body is 1.5 mass % or higher and 4.0 mass % or lower.

2. The electrode for discharge surface treatment of claim 1, wherein the metal macro-powder has a median diameter not smaller than 8.5 micrometers and not larger than 10 micrometers.

3. The electrode for discharge surface treatment of claim 2, wherein the metal macro-powder has a 10% accumulated particle diameter not smaller than 3 micrometers and a 90% accumulated particle diameter not smaller than 12 micrometers and not larger than 15 micrometers.

4. The electrode for discharge surface treatment of claim 1, wherein the oxygen content rate of the sintered body is 2.0 mass % or higher and 3.8 mass % or lower.

5. The electrode for discharge surface treatment of claim 1, wherein an electric resistivity of the sintered body is not smaller than 3 mΩ·cm and not larger than 30 mΩ·cm.

6. The electrode for discharge surface treatment of claim 1, wherein a density of the sintered body is not smaller than 3 g/cm³ and not larger than 5 g/cm³.

7. The electrode for discharge surface treatment of claim 1, wherein a content rate of the metal macro-powder is higher than 0 mass % and not higher than 70 mass % where a sum of the metal micro-powder and the metal macro-powder is 100 mass %.

8. The electrode for discharge surface treatment of claim 1, wherein the metal micro-powder and the metal macro-powder are formed of a metal material with identical alloy components, and
wherein the metal material is a Cr-containing Co alloy, a Cr-containing Ni alloy or a Cr-containing Fe alloy.

9. A production method for an electrode for discharge surface treatment, comprising:
an electrode powder formation step for forming an electrode powder including a metal micro-powder having a median diameter of 3 micrometers or smaller and a metal macro-powder having a median diameter larger than 3 micrometers and not larger than 10 micrometers, wherein the metal micro-powder and the metal macro-powder include Cr and oxygen;
a granulation step for mixing and granulating the metal micro-powder and the metal macro-powder to form a granulated powder;
a compression molding step for compressing and molding the granulated powder under a pressure of from 20 MPa to 300 MPa to form a compressed body; and
a firing step for firing the compressed body at from 450 degrees C. to 950 degrees C. to form a sintered body.

10. The production method for the electrode for discharge surface treatment of claim 9, wherein the metal macro-powder has a median diameter not smaller than 8.5 micrometers and not larger than 10 micrometers.

11. The production method for the electrode for discharge surface treatment of claim 10, wherein the metal macro-powder has a 10% accumulated particle diameter not smaller than 3 micrometers and a 90% accumulated particle diameter not smaller than 12 micrometers and not larger than 15 micrometers.

12. The production method for the electrode for discharge surface treatment of claim 9, wherein a content rate of the metal macro-powder is higher than 0 mass % and not higher than 70 mass % where a sum of the metal micro-powder and the metal macro-powder is 100 mass %.

13. The production method for the electrode for discharge surface treatment of claim 9, wherein, in the compression molding step, the compressed body is finally pressed by cold hydrostatic pressing under a smaller pressure as a mixing ratio of the metal macro-powder is larger.

14. The production method for the electrode for discharge surface treatment o of claim 9, wherein, in the firing step, the compressed body is fired at a higher temperature as a mixing ratio of the metal macro-powder is larger.

15. The production method for the electrode for discharge surface treatment of claim 9, wherein the metal material is a Cr-containing Co alloy, a Cr-containing Ni alloy or a Cr-containing Fe alloy.
